(19) United States
(12) Patent Application Publication
(10) Pub. No.: US 2012/0096368 A1
(43) Pub. Date: Apr. 19, 2012

(54) CLOUD-BASED VIRTUAL CLIPBOARD

(75) Inventor: Brian McDowell, Woodinville, WA (US)

(73) Assignee: MICROSOFT CORPORATION, Redmond, WA (US)

(21) Appl. No.: 12/904,833

(22) Filed: Oct. 14, 2010

(51) Int. Cl. G06F 15/16; G06F 3/01; G06F 21/00

(52) U.S. Cl. 715/748; 709/234; 726/1

(57) ABSTRACT

A system and method are disclosed for quickly and easily making data from one device available to other devices in a user's collection of computing devices. In one example, each of a user's computing devices includes a client-side clipboard application. A cloud clipboard service may be resident on a server to which each of the user's computing devices are operatively connected. Data from a local clipboard buffer on a user's computing device is automatically uploaded by the associated client-side clipboard application to the cloud clipboard service. Thereafter, the uploaded data it is automatically propagated to a user's other networked devices for use on those devices. Data from one user uploaded to the cloud clipboard service may also be propagated to the devices of one or more other users.

### BACKGROUND

The current trend in computing is away from mainframe systems toward cloud computing. Cloud computing is Internet-based computing, whereby shared resources such as software and other information are provided to a variety of computing devices on-demand via the Internet. It represents a new consumption and delivery model for IT services where resources are available to all network-capable devices, as opposed to older network models where resources were stored locally across the devices. The move toward cloud computing opens up a new potential for mobile and other networked devices to work in conjunction with each other to provide greater interaction and a much richer experience with respect to third party and a user's own resources.

One advantage of cloud computing is that it offers enhanced connectivity between a user's various devices, such as for example smart phones, Internet-connected television or set-top boxes, laptops, netbooks, and desktop computers. Despite this enhanced connectivity, where a user wishes to transfer data such as a picture, document or a selection of text from one device to another, the user is still forced to perform a series of complex tasks to achieve this data transfer. These tasks may be time consuming and non-intuitive to perform.

### SUMMARY

The technology, briefly described, comprises a system and method for quickly and easily making data from one computing device available to the other devices in a user's collection of computing devices. In one example, the system includes a client-side clipboard application on each device in a user's collection of computing devices. The client-side clipboard application may be a software module running as part of a computing device's operating system, or as an application in communication with the operating system. The system further includes a cloud clipboard service resident on a server to which each of the user's computing devices are operatively connected.

For each computing device in a user's collection of computing devices, the client-side clipboard application monitors a local clipboard buffer to which data may be copied by a user performing a known cut or copy operation on data in a device-level application. The data which may be copied in the present system may be any data which can be copied to a local clipboard buffer in any of a wide variety of applications, including text, graphics, files, directories, and links to such data. Upon a change in the data in the local clipboard buffer, the client-side clipboard application retrieves that data and pushes it to the cloud clipboard service to which the computing device is connected.

Thereafter, the data in the cloud clipboard service is transmitted to the client-side clipboard applications in the other computing devices in a user's collection. Upon receipt, the client-side clipboard application takes the received data and stores it in the associated local clipboard buffer, replacing data that may have been there previously. Thereafter, a user may perform a known paste operation from any of his networked computing devices to paste the data received from the cloud clipboard service into one or more device-level applications.

In this way, data from one computing device may be easily propagated to other devices in a user's collection of devices. In a further embodiment, a similar system may be used to propagate data from one user's device to the devices of others in a friend network where permissions have been properly set.

In one example, the present technology relates to a method of propagating data between multiple computing devices, comprising: a) monitoring a local clipboard buffer of a first computing device of the multiple computing devices for a change in data stored in the local clipboard buffer; b) transmitting data from the local clipboard buffer of the first computing device to a storage location on a remote server to which the first computing device is operatively coupled upon detecting a change in the data stored in the local clipboard buffer of the first device; and c) propagating the data stored in the storage location in said step b) to a local clipboard buffer of a second computing device operatively coupled to the remote server.

In another example, the present technology relates to a system for propagating data between computing devices. The system includes: a first computing device including: a first application including data, a first local clipboard buffer capable of storing data copied to the first local clipboard buffer from the first application, and a first client clipboard application for synchronizing with the first local clipboard buffer and forwarding the data in the first local clipboard buffer to a remote location; a service at the remote location, the service including: a data store for storing the data from the first client clipboard application; and a second computing device operative coupled to the service at the remote location, the second computing device including: a second client clipboard application for synchronizing with the data store in the service at the remote location, a second local clipboard buffer, the second client clipboard application forwarding data received from the data store to the second local clipboard buffer, data in the second local clipboard buffer being replaced with data received from the second client clipboard application, and a second application, data from the second local clipboard buffer capable of being pasted into the application.

In a further example, the present technology relates to a computer-readable storage medium for programming a processor to perform a method of propagating data between a collection of computing devices of a single user. The performed method comprising: a) synchronizing a local clipboard buffer of a first computing device of a collection of computing devices of the single user to a first client clipboard application on the first computing device; b) transmitting data from the local clipboard buffer of the first computing device to a storage location on a remote server to which the first computing device is operatively coupled upon detecting a change in the data stored in the local clipboard buffer of the first device; and c) propagating the data stored in the storage location in said step b) to local clipboard buffers of a plurality of computing devices in the user's collection of computing devices that are operatively coupled to the remote server.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of a network architecture for implementing an embodiment of the present technology.

FIG. 2 is a block diagram of client-side and server-side components for implementing the present technology.

FIG. 3 is a flowchart for implementing an embodiment of the present system shown in FIG. 2.

FIG. 4 is a block diagram of client-side and server-side components for implementing an alternative embodiment of the present technology.

FIG. 5 is a flowchart for implementing the alternative embodiment of the present system shown in FIG. 4.

FIG. 6 is an illustration of an example for copying and pasting data in a natural user interface.

FIG. 7 is a block diagram of an exemplary computing environment.

FIG. 8 is a block diagram of an exemplary gaming console.

### DETAILED DESCRIPTION

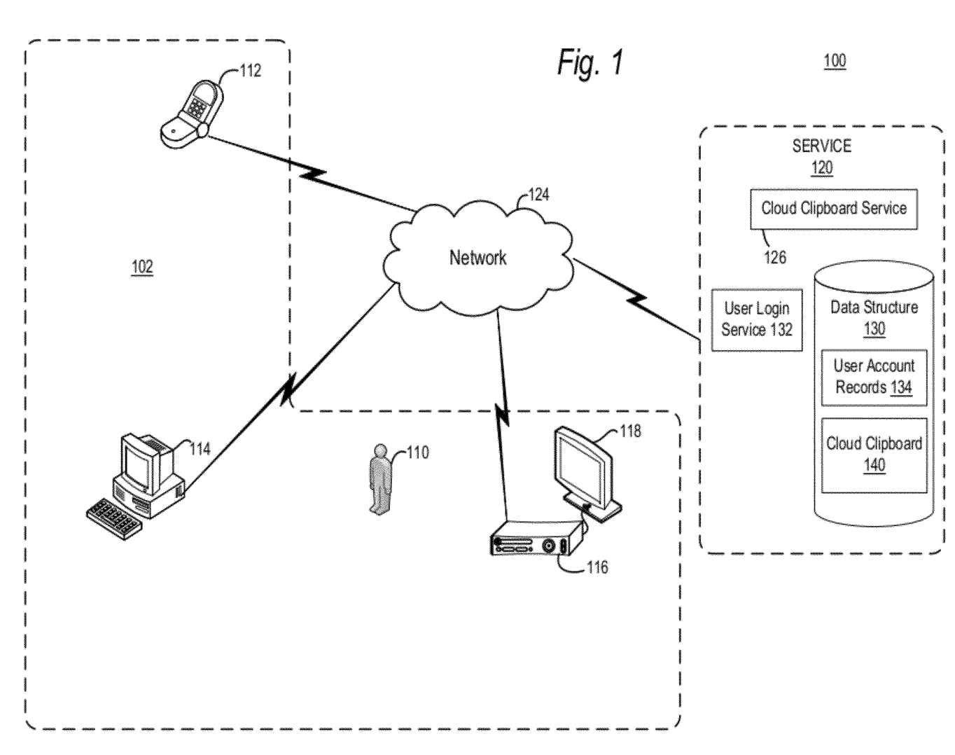

Embodiments of the present technology will now be described with reference to FIGS. 1 through 8, which in general relate to a system and method for quickly and easily making data from one device available to other devices in a user's collection of computing devices. In one example, the system includes a client-side clipboard application, which is a software module running as part of a computing device's operating system, or as an application in communication with the operating system, on each device in a user's collection of computing devices. The system further includes a cloud clipboard service resident on a server to which each of the user's computing devices is operatively connected.

A user may perform cut, copy and paste operations which are known for copying data to a local clipboard buffer and retrieving data from a local clipboard buffer. However, in accordance with the present system, any cut or copied data may also be automatically uploaded to the cloud clipboard service, whereupon it is automatically propagated to a user's other networked devices for use on those devices. In embodiments, data from one user uploaded to the cloud clipboard service may also be propagated to the devices of one or more other users. These principals and others of the present technology are explained below in greater detail.

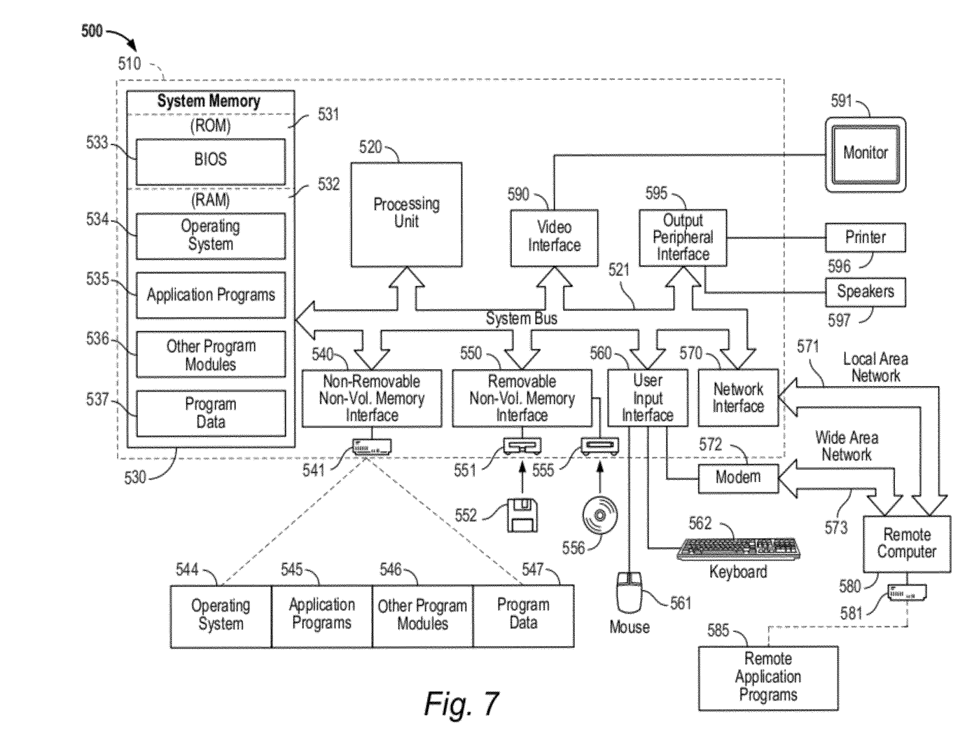

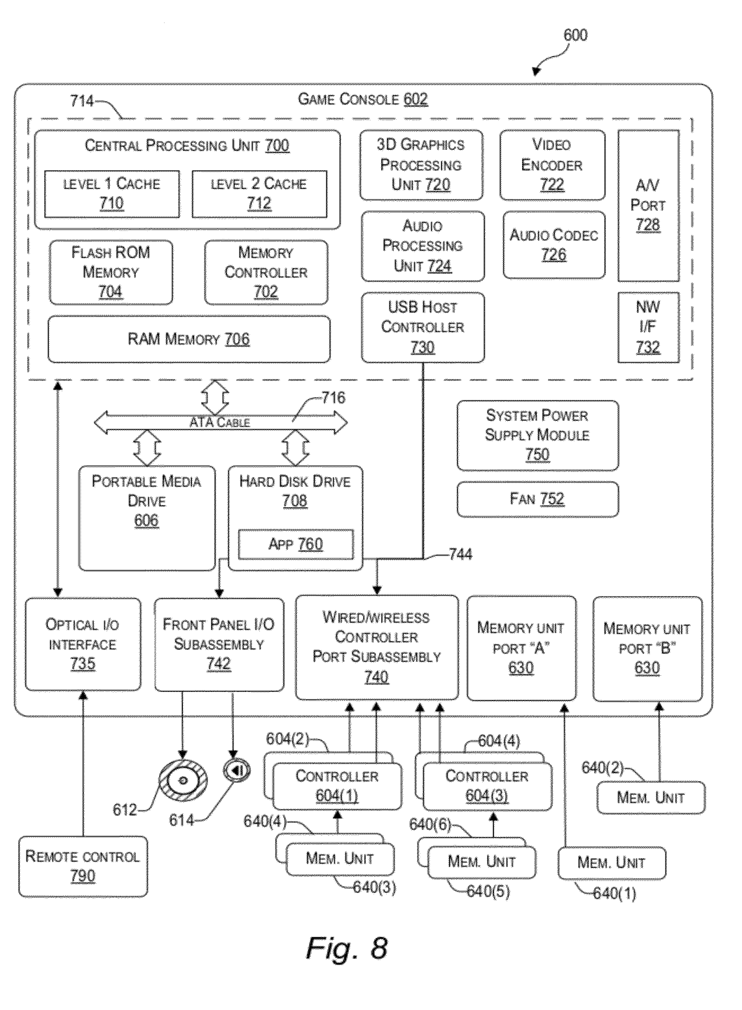

FIG. 1 shows a block diagram of a sample network topology 100 for implementing the present technology. Network topology 100 includes a collection 102 of computing devices 112, 114, 116. These computing devices form part or all of a collection of computing devices belonging to a single user 110 and operatively coupled to a service 120 via a network 124. In one example, computing device 112 may be a mobile telephone of a mobile telephone network, computing device 114 may be a personal computer such as a desktop computer, laptop computer or tablet, and computing device 116 may be a set-top box or game console having an associated display 118. Example embodiments of these computing devices are set forth below with respect to FIGS. 7 and 8.

Each of the various types of computing devices may store their data locally and “in the cloud,” for example on a storage location 130 in service 120 as explained below. The computing devices 112, 114, 116 shown in FIG. 1 are by way of example only and one or more of these may be omitted in further embodiments. Moreover, the user 110 may have a variety of other computing devices, or additional replicas of the computing devices 112, 114, 116, in his or her collection 102 of computing devices in further embodiments. Such computing devices may in general include, but are not limited to, desktop computers, laptop computers, tablets, cellular telephones, televisions/set top boxes, video game consoles, netbooks, automobiles, cameras and smart appliances. Other computing devices are contemplated.

The service 120 may for example be a large scale Internet service provider such as for example MSN® services or Xbox LIVE® gaming services, though it need not be in further embodiments. Service 120 may have one or more servers including one implementing a cloud-based clipboard service 126 as explained below. Service 120 may include other servers including for example a web server, a game server supporting gaming applications, a media server for organizing and distributing selected media, and/or an ftp server supporting file transfer and/or other types of servers. Other servers are contemplated.

In embodiments, each of the computing devices illustrated in FIG. 1 may be coupled to each other via one or more public or private networks 124. Network 124 may include the Internet, cellular networks, or any other type of known public or private data and/or voice transfer network. In further embodiments, computing devices 112, 114, 116 may be connected to each other by peer-to-peer connections in addition to, or instead of, their connection to network 124.

The service 120 also provides a collection of services which applications running on computing devices 112, 114, 116 may invoke and utilize. For example, computing devices 112, 114, 116 may invoke user login service 132, which is used to authenticate the user 110 seeking access to his or her secure resources from service 120. A user 110 may authenticate him or herself to the service 120 by a variety of authentication protocols, including for example with an ID such as a username and a password.

Where authentication is performed by the service 120, the ID and password may be stored in user account records 134 within a data structure 130. Data structure 130 may further include a cloud clipboard storage location 140 for storing a wide variety of clipboard data as explained below. While the cloud clipboard service 126, data structure 130 and login service 132 are shown as part of a single service 120, some or all of these components may be distributed across different services in further embodiments.

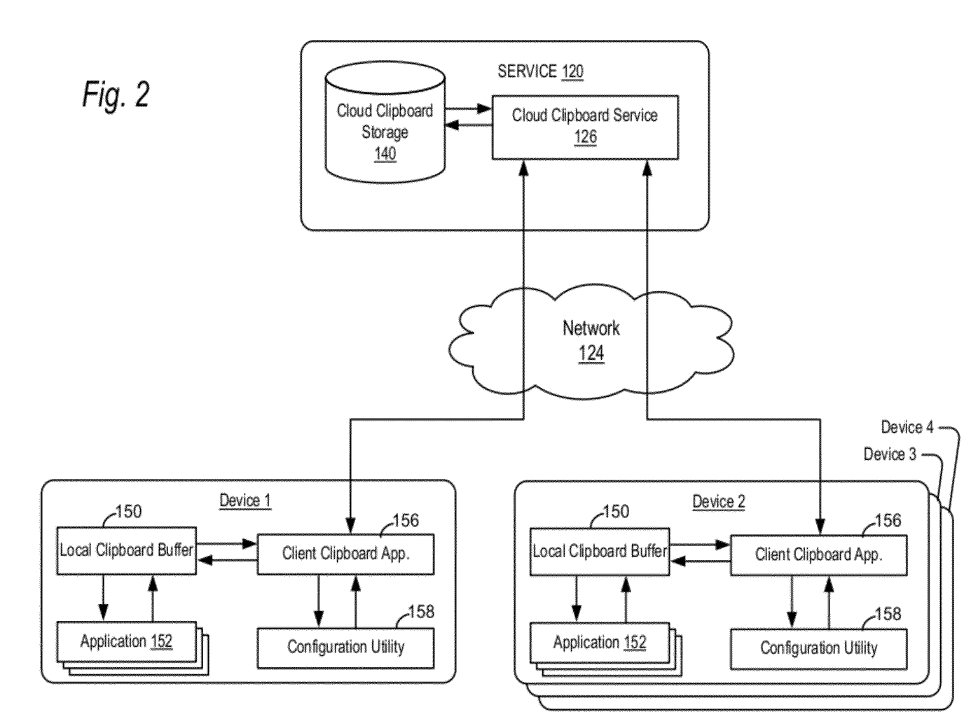

Referring now to the block diagram of FIG. 2, there is shown the service 120 including cloud clipboard service 126 and cloud clipboard storage 140. The service 126 may be operatively coupled via network 124 to the computing devices in a user's collection 102 of computing devices. In the description below, the transfer of data from a device 1 to devices 2, 3 and 4, etc. is described. It is understood that there may be greater or fewer computing devices than shown in FIG. 2. Moreover, any of the computing devices in a user's collection of computing devices can occupy the position of device 1 to allow data from that device to be quickly and easily propagated to other devices in the user's collection of computing devices. Aspects of computing device 1 related to the present system are explained below. It is understood that each of the other devices 2, 3, 4, etc. may include the same components.

Device 1 includes a local clipboard buffer 150 receiving data from and sending data to one or more device-level applications 152 on device 1. Local clipboard buffer 150 may be a block of memory in the random access memory (RAM) of device 1. Data may be written to local clipboard buffer 150 via different user interface commands commonly referred to as cut and/or copy operations. Different user interfaces will have different forms of these commands.

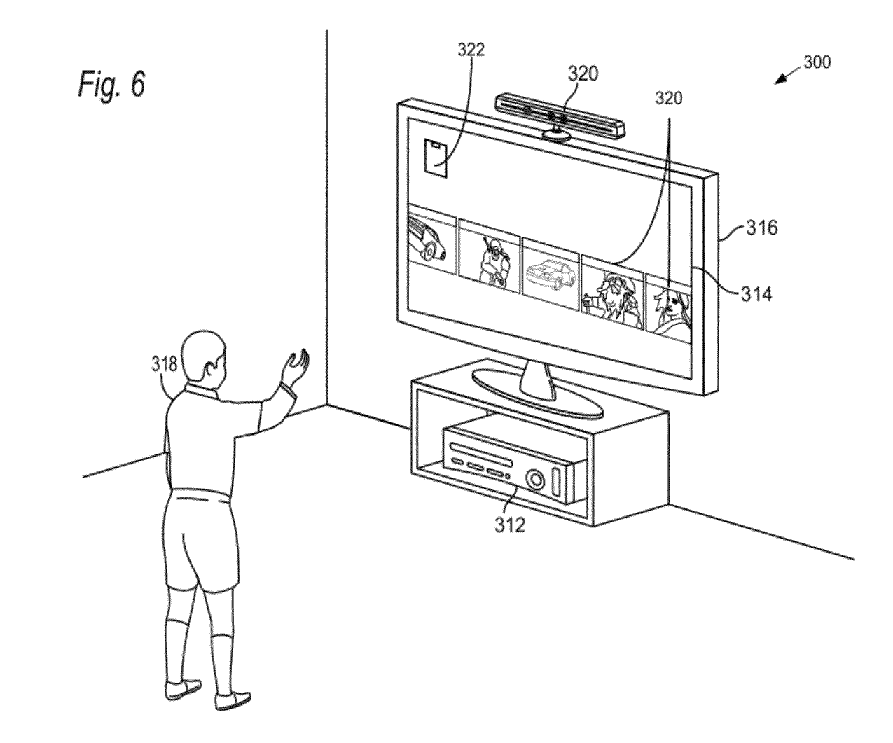

In one common example, operating systems working with a keyboard could recognize a keyboard stroke shortcut of “Ctrl-x” to cut selected data objects, whereupon they are copied to the local clipboard buffer 150, and “Ctrl-c” to copy selected data objects to the local clipboard buffer 150. Such systems typically also recognize a shortcut keystroke of “Ctrl-v” to paste objects stored in local clipboard buffer 150 to a device-level application 152. FIG. 6, described below, shows a further embodiment for copying and pasting data objects in a natural user interface. Further details relating to the configuration and operation of a conventional local clipboard buffer are described for example in Microsoft developer network documents found for example at http://msdn.microsoft.com\en-us\library\ms648709(VS.85).aspx and links sited therein, which documents are incorporated by reference herein in their entirety.

Each device may further include a client clipboard application 156 which may be a software module or a combination of hardware and software running on device 1. The client clipboard application may be part of the device's operating system, or may be an application in communication with the operating system. Client clipboard application 156 may monitor and synchronize with the local clipboard buffer 150 so that, upon a change in the data stored in local clipboard buffer 150, the client clipboard application automatically receives this data. The client clipboard application 156 may then automatically forward the received data to cloud clipboard service 126.

Client clipboard application 156 may monitor local clipboard buffer 150 continuously, or periodically. Alternatively, the local clipboard buffer 150 may be modified to push data from the buffer to client clipboard application 156 upon a change in the data in the local clipboard buffer 150. The type of data which can be forwarded by the client clipboard application 156 to the cloud clipboard service 126 may be any type of data which can be stored in a local clipboard buffer 150 in any application 152 running on device 1. This data may for example include text, graphics, one or more files, one or more file directories, and links to such data. Different applications 152 may have different types of data which it can operate with and store in local clipboard buffer 150. Client clipboard application 156 may receive any type of data from buffer 150 and forward it to cloud clipboard service 126.

Each user device may further include a configuration utility 158 allowing a user to configure aspects of the cloud-based clipboard service. The utility 158 may present a user interface through which a user can configure a desired implementation of the present system. The utility 158 may for example allow a user to define each of his or her devices which are to be included in the cloud-based clipboard service, as well as to provide logon credentials authenticating the user to his or her collection of computing devices. In this respect, the configuration utility may interact with the user logon service 132 described above. User login information may be cached so that a user need not enter login credentials each time a user uses the cloud-based clipboard service.

The user may set a variety of other user preferences via the configuration utility 158. In embodiments, the user may choose which types of data should be shared, which data connection to prioritize (e.g., on a phone, the user might prefer to use a wi-fi over a data-plan connection if both are available), which applications are excluded from the shared clipboard, and possibly configure conversion rules for data formats (for example, all images should be converted to jpeg format). Other configurations are possible via configuration utility 158.

Each of devices 1, 2, 3, 4, etc., may include a local clipboard buffer 150, applications 152, client clipboard application 156 and utility application 158 as described above.

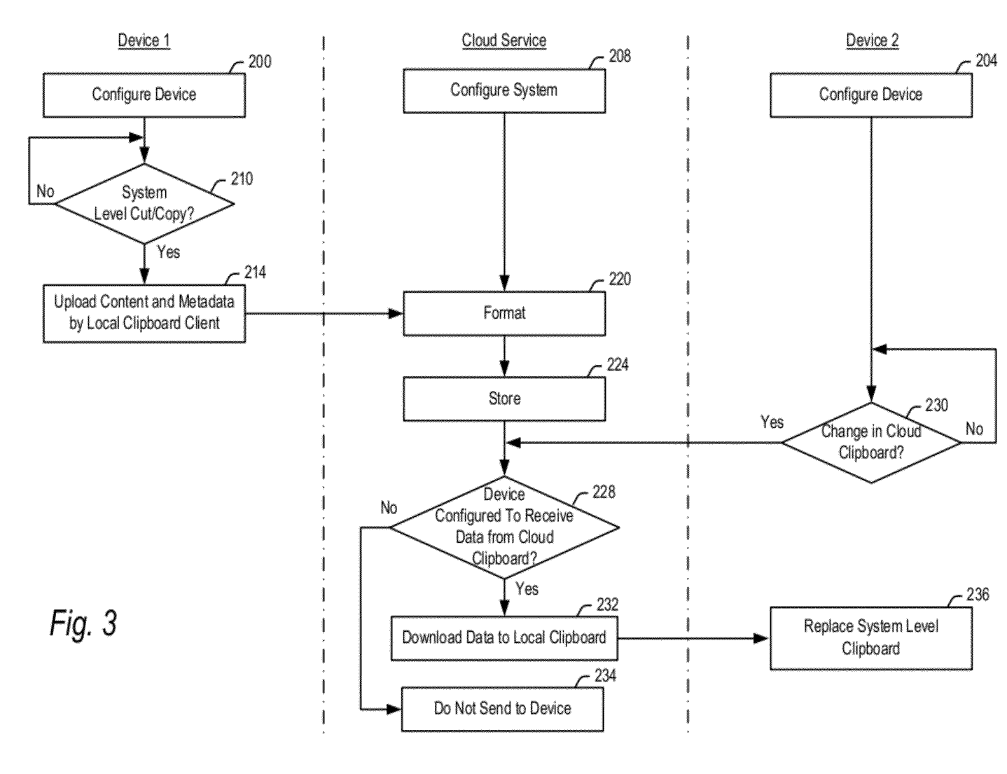

An operation of the system shown in FIG. 2 will now be described with reference to the flowchart of FIG. 3. In step 200, a user of the device 1 may configure the device as described above in the preceding paragraph. A user may use any of the devices in his or her collection 102 to configure the system, such as for example alternatively using device 2 to configure the system in step 204. As a further alternative, a user may access service 120 directly, and configure the system through interaction with the service 120 in a step 208.

In step 210, the client clipboard application 156 monitors the local clipboard buffer 150 for a cut or copy operation that causes data to be copied to the local clipboard buffer 150. Upon detecting new data in a local clipboard buffer 150, the client clipboard application 156 uploads the new data to cloud service 126 in step 214. In step 214, the client clipboard application 156 may additionally upload metadata associated with the data to be propagated. In particular, the metadata may include the type of device that generated the data, the application on the device which generated the data, the type of data (text, graphics, video, html) and a time stamp at which the data was copied to the local clipboard buffer 150 on the device. All this data and metadata may be sent to the cloud clipboard service 126 in step 214.

In step 220, the cloud clipboard service 126 may format the data to maximize its usability across different devices and different applications. Formatting step 220 may in examples include the step of stripping out formatting of the data uploaded in step 214. The data may be formatted per user preferences set forth via the configuration utility 158, or a default set of rules directed at optimizing the possibility that the stored data may be viewed on a maximum number of devices and in a maximum number of applications on those devices. In embodiments, multiple versions of the data may be generated in step 220, with each version having a different format to again maximize the usability of the data across different devices and applications. After formatting in step 220, the data may be stored in cloud clipboard storage 140 in step 224.

As in conventional local clipboard buffers, when new data is stored in cloud clipboard storage 140 in step 224, any data that was previously stored may be replaced. In embodiments, it is conceivable that replaced data may be maintained and that the user be provided with the ability to view data that was stored in cloud clipboard storage 140 at different times.

Device 2 (and/or device 3, 4, etc.) monitors the cloud clipboard service 126 for changes in the data stored in the clipboard in step 230. The devices in the user's collection 102 may monitor the cloud clipboard service 126 continuously or periodically for changes in the data stored in the cloud clipboard storage 140. In an alternative embodiment, instead of devices checking the cloud clipboard service 126 for changes in stored data and pulling data down, the cloud clipboard service 126 may automatically push new data down to the connected computing devices in the user's collection 102 upon a change of data in cloud clipboard storage 140.

Whether initiated by the client-side clipboard application or server-side clipboard service, when new data is to be propagated to other devices in a user's collection 102, the cloud clipboard service 126 first checks if a given device is permitted and is configured to receive data from the cloud clipboard service in step 228. If a device is not configured to receive data from the cloud clipboard service 126 then nothing is sent (step 234).

On the other hand, if a given device in a user's collection 102 is approved and configured to receive data from the cloud clipboard service in step 228, that data is downloaded to the device in step 232. Upon receipt, the client clipboard application 156 on the receiving device replaces any existing data in a local clipboard buffer 150 with the data received from the cloud clipboard service 126 in step 236. Thereafter, the received data may be pasted into any of a variety of device level applications 152 using a conventional paste operation.

Using the above-described system, data on one device may be automatically propagated to all the devices in a user's collection of computing devices having a continuous or intermittent connection with service 120. As noted above, data from any of the devices in a user's collection of computing devices may be propagated as described above. Thus, device 1 of FIGS. 2 and 3 may similarly receive data from cloud clipboard service 126 from one or more of the other computing devices in the collection. The service 126 will maintain security and privacy rules protecting the content of the clipboard, based on the user settings entered for example via the configuration utility 158.

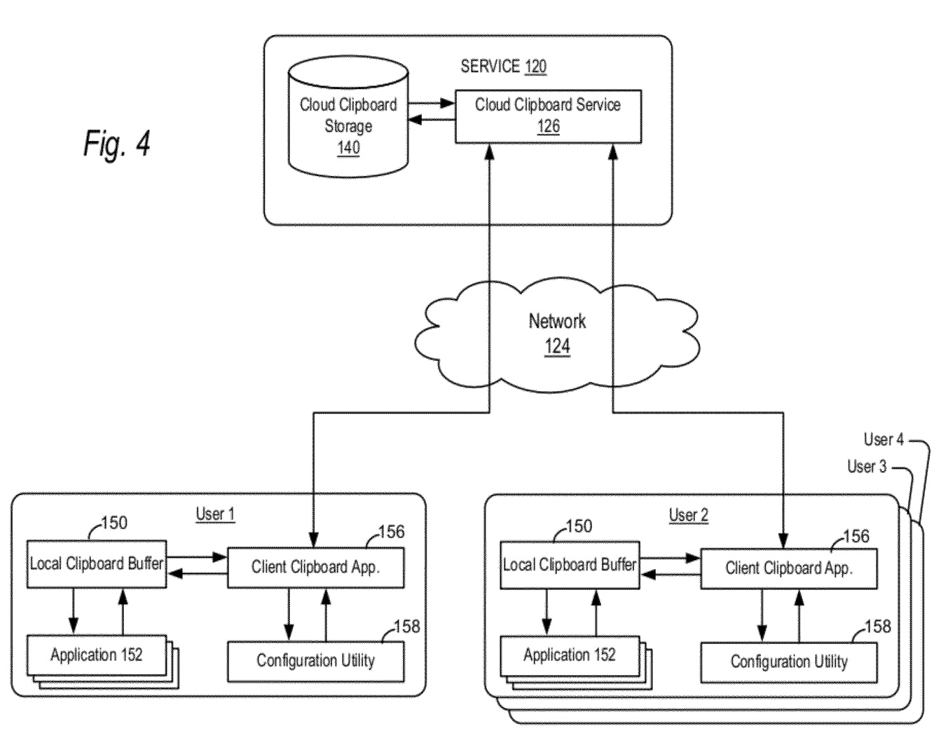

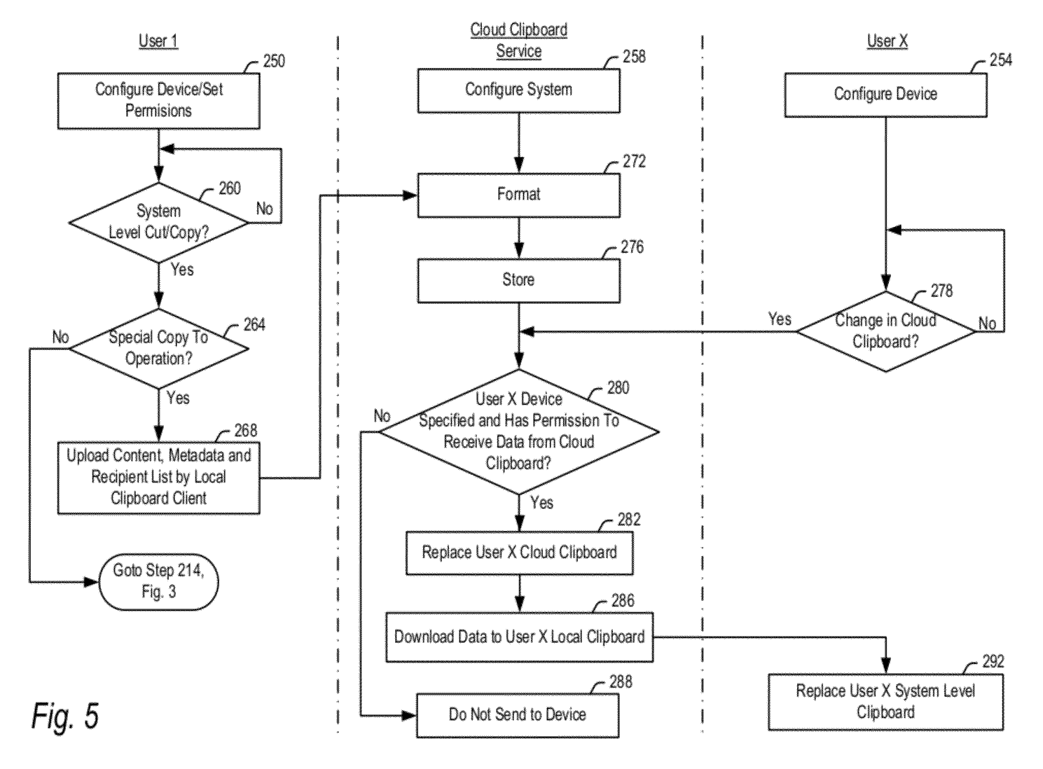

In the embodiments described above, a user is able to propagate data from one device to one or more other devices in the user's own collection of computing devices. In a further embodiment of the present system, a user may propagate data from one of his or her computing devices to the computing devices of one or more other users. Such an embodiment is shown in the block diagram of FIG. 4 and described below with respect to the flowchart of FIG. 5.

FIG. 4 is similar to FIG. 2, with the exception that the user 1 shown on FIG. 4 is a device from the collection 102 of user 1; and user 2, user 3 and user 4 are computing devices from the collections of user 2, user 3 and user 4, respectively. As above, it is understood that the system may include greater or fewer numbers of computing devices in further embodiments. Referring now to the flowchart of FIG. 5, in step 250, a user may configure the cloud clipboard service 126 via configuration utility 158 as described above. In addition to the permissions and user preferences described above, a user may further set permissions specifying which other users may receive data from user 1 via the cloud clipboard service.

FIG. 5 shows a system where data from a computing device of user 1 is propagated through the cloud clipboard service 126 to the computing device of a user x, which may be any of the users 2, 3, 4, etc. In step 254, the user x may also configure his or her system and set permissions to receive data of user 1 via the cloud clipboard service 126. The cloud clipboard service 126 may operate to transfer data from user 1 to user x when there is two-way confirmation to send and receive data. That is, data is propagated from user 1 to user x when user 1 has set permissions to send clipboard data to user x, and when user x has set permissions to receive clipboard data from user 1. As discussed above, user 1 and/or user x may contact service 120 directly to configure the cloud clipboard service 126 in a step 258.

In step 260, the client clipboard application 156 of a device of user 1 may look for a local cut or copy operation as described above. If one is found, the system checks in step 264 if it is a special “copy to” operation. In particular, a client clipboard application 156 may allow a user to perform a special cut or copy operation where the user is given the option not only to copy data but also to specify to whom the data is to be sent. The recipient may be a single user, multiple users, or a defined group of users. The identities of the users and user groups may be made by the users and stored in account records 134 in data structure 130 of service 120.

In step 264, the client clipboard application 156 of user 1 senses whether user 1 is performing a special copy operation. If not, the client clipboard application performs a data propagation across his or her own devices only, as described above with respect to the flowchart of FIG. 3 (the system may perform from step 214 of FIG. 3 onward). On the other hand, if it is determined that step 384 had the user performing a special “copy to” operation, the client clipboard application 156 may upload the content, metadata and recipient list to cloud clipboard service 126 in step 268. Upon receipt, the cloud clipboard service 126 may format the data (step 272) and store the data (step 276) as described above. In a special “copy to” operation, the data may be propagated to the user's other computing devices in his collection (per the flowchart of FIG. 3) in addition to being sent to the specified recipients.

In step 278, the client clipboard application 156 on the computing device of user x may check for updates in the cloud clipboard storage 140. Upon an update, the cloud clipboard service 126 may check in a step 280 whether user x device is specified and has permission to receive data from user 1 via the cloud clipboard service 126. If not, data is not sent to the user x device (step 288).

On the other hand, if the permissions from user 1 and user x are such that user x may receive data from user 1 via the cloud clipboard service 126, the cloud clipboard service 126 writes the data to the cloud clipboard storage 140 for user x in step 282 and downloads the data in step 286 to the client clipboard application 156 in user x's collection of computing devices. In step 292, the client clipboard application 156 on user x's computing devices updates the local clipboard buffer 150 on each such device. Thereafter, user x may paste the data from local clipboard buffer 150 into an application from any device in user x's collection of computing devices.

As noted above, cut, copy and paste operations are well-known when performed using a keyboard and/or mouse user interactive devices. FIG. 6 is an embodiment illustrating copy and paste operations in a natural user interface (NUI) system. In general, the NUI system of FIG. 6 includes a target recognition, analysis, and tracking system 300 which may be used to recognize, analyze, and/or track a human target such as the user 318. Embodiments of the target recognition, analysis, and tracking system 300 include a computing environment 312 for executing a gaming or other application. The computing environment 312 may include hardware components and/or software components such that computing environment 312 may be used to execute applications such as gaming and non-gaming applications. Computing environment further includes a client clipboard application 156 associated with a local clipboard buffer 150 as described above. In one embodiment, computing environment 312 may include a processor such as a standardized processor, a specialized processor, a microprocessor, or the like that may execute instructions stored on a processor readable storage device for performing processes described herein.

The system 300 further includes a capture device 320 for capturing image and audio data relating to one or more users and/or objects sensed by the capture device. The capture device 320 may include a three-dimensional depth camera and a video camera such as an RGB camera to capture depth data and color and texture data related to a captured schene. In embodiments, the capture device 320 may be used to capture information relating to movements, gestures and speech of one or more users, which information is received by the computing environment and used to render, interact with and/or control aspects of a gaming or other application.

Embodiments of the target recognition, analysis and tracking system 300 may be connected to an audio/visual device 316 having a display 314. The device 316 may for example be a television, a monitor, a high-definition television (HDTV), or the like that may provide game or application visuals and/or audio to a user. For example, the computing environment 312 may include a video adapter such as a graphics card and/or an audio adapter such as a sound card that may provide audio/visual signals associated with the game or other application. The audio/visual device 316 may receive the audio/visual signals from the computing environment 312 and may then output the game or application visuals and/or audio associated with the audio/visual signals to the user 318. According to one embodiment, the audio/visual device 316 may be connected to the computing environment 312 via, for example, an S-Video cable, a coaxial cable, an HDMI cable, a DVI cable, a VGA cable, a component video cable, or the like.

The system 300 may be used to interpret user 318 movements as operating system and/or application controls that are outside the realm of games or the specific application running on computing environment 312. As one example, a user may scroll through and control interaction with a variety of menu options presented on the display 314. Virtually any controllable aspect of an operating system and/or application may be controlled by the movements of the user 318. For example, in accordance with the present technology, the user may perform movements that copy data objects to a local data buffer 150 (not shown in FIG. 6) by “placing” the data objects on a graphical representation 322 of a clipboard.

In particular, FIG. 6 illustrates an example including a number of data objects 320 on display 314. Data objects 320 shown may for example be gaming or other applications, but it is understood that data objects 320 may be any of a variety of other data including for example text, audio files, directories, etc. In one embodiment, a user may select one or more of the data objects 320 by pointing at the object with his hand, and then indicating selection of the object by performing a grabbing motion with his hand. This may be interpreted as a system command indicating the user wishes to copy the selected data object.

Thereafter, the user 318 may add a selected graphical object 320 to the local clipboard buffer 150 within computing system 312. The user may accomplish this by moving his hand so as to move one or more of the data objects 320 on the screen over to graphical clipboard 322. This display may for example show the selected object moving toward the graphical clipboard 322 with a variety of visual effects. This motion may add the selected data object 320 to local clipboard buffer 150 on system 312. A client clipboard application 156 on system 312 may then upload the data object to cloud clipboard service 126 as explained above.

Similarly, data from another device from user 318 (or another user) may be downloaded to system 312, whereupon the client clipboard application 156 within system 312 moves that data to the local clipboard buffer 150. A user may then paste that data, for example onto display 314, by “grabbing” the data from clipboard 322 and, upon further movement of his hand, place that data somewhere on display 314. It is understood that the above described system is by way of example only, and a wide variety of other NUI interface operations may be used to copy data from system 300 up to cloud clipboard service 126, and to download data from cloud clipboard service 126 to the system 300. Where this data is graphical in nature it may then be pasted onto display 314. Alternatively, for example where it is audio, it may be played over speakers associated with the system 300.

Suitable examples of a system 300 and components thereof are found in the following co-pending patent applications, all of which are hereby specifically incorporated by reference: U.S. patent application Ser. No. 12/475,094, entitled “Environment and/or Target Segmentation,” filed May 29, 2009; U.S. patent application Ser. No. 12/511,850, entitled “Auto Generating a Visual Representation,” filed Jul. 29, 2009; U.S. patent application Ser. No. 12/474,655, entitled “Gesture Tool,” filed May 29, 2009; U.S. patent application Ser. No. 12/603,437, entitled “Pose Tracking Pipeline,” filed Oct. 21, 2009; U.S. patent application Ser. No. 12/475,308, entitled “Device for Identifying and Tracking Multiple Humans Over Time,” filed May 29, 2009; U.S. patent application Ser. No. 12/575,388, entitled “Human Tracking System,” filed Oct. 7, 2009; U.S. patent application Ser. No. 12/422,661, entitled “Gesture Recognizer System Architecture,” filed Apr. 13, 2009; U.S. patent application Ser. No. 12/391,150, entitled “Standard Gestures,” filed Feb. 23, 2009; and U.S. patent application Ser. No. 12/474,655, entitled “Gesture Tool,” filed May 29, 2009.

FIG. 7 illustrates an example of a suitable general computing system environment 500 that may comprise for example the desktop or laptop computing device 114. The computing system environment 500 is only one example of a suitable computing environment and is not intended to suggest any limitation as to the scope of use or functionality of the inventive system. Neither should the computing system environment 500 be interpreted as having any dependency or requirement relating to any one or combination of components illustrated in the exemplary computing system environment 500.

The inventive system is operational with numerous other general purpose or special purpose computing systems, environments or configurations. Examples of well known computing systems, environments and/or configurations that may be suitable for use with the present system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 7, an exemplary system for implementing the present technology includes a general purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 may include a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 530 includes computer storage media in the form of volatile and/or nonvolatile memory such as ROM 531 and RAM 532. A basic input/output system (BIOS) 533, containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 7 illustrates operating system 534, application programs 535, other program modules 536, and program data 537.

The computer 510 may also include other removable/non-removable, volatile/nonvolatile computer storage media. By way of example only, FIG. 7 illustrates a hard disc drive 541 that reads from or writes to non-removable, nonvolatile magnetic media and a magnetic disc drive 551 that reads from or writes to a removable, nonvolatile magnetic disc 552. Computer 510 may further include an optical media reading device 555 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 541 is typically connected to the system bus 521 through a non-removable memory interface such as interface 540, magnetic disc drive 551 and optical media reading device 555 are typically connected to the system bus 521 by a removable memory interface, such as interface 550.

The drives and their associated computer storage media discussed above and illustrated in FIG. 7, provide storage of computer readable instructions, data structures, program modules and other data for the computer 510. In FIG. 7, for example, hard disc drive 541 is illustrated as storing operating system 544, application programs 545, other program modules 546, and program data 547. These components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and a pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus 521, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through an output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 7. The logical connections depicted in FIG. 7 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communication over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 7 illustrates remote application programs 585 as residing on memory device 581. It will be appreciated that the network connections shown are exemplary and other means of establishing a communication link between the computers may be used.

FIG. 8 is a functional block diagram of gaming and media system 600, and shows functional components of gaming and media system 600 in more detail. System 600 may be the same as the computing device 116 described above. Console 602 has a central processing unit (CPU) 700, and a memory controller 702 that facilitates processor access to various types of memory, including a flash Read Only Memory (ROM) 704, a Random Access Memory (RAM) 706, a hard disk drive 708, and portable media drive 606. In one implementation, CPU 700 includes a level 1 cache 710 and a level 2 cache 712, to temporarily store data and hence reduce the number of memory access cycles made to the hard drive 708, thereby improving processing speed and throughput.

CPU 700, memory controller 702, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 700, memory controller 702, ROM 704, and RAM 706 are integrated onto a common module 714. In this implementation, ROM 704 is configured as a flash ROM that is connected to memory controller 702 via a PCI bus and a ROM bus (neither of which are shown). RAM 706 is configured as multiple Double Data Rate Synchronous Dynamic RAM (DDR SDRAM) modules that are independently controlled by memory controller 702 via separate buses (not shown). Hard disk drive 708 and portable media drive 606 are shown connected to the memory controller 702 via the PCI bus and an AT Attachment (ATA) bus 716. However, in other implementations, dedicated data bus structures of different types can also be applied in the alternative.

A three-dimensional graphics processing unit 720 and a video encoder 722 form a video processing pipeline for high speed and high resolution (e.g., High Definition) graphics processing. Data are carried from graphics processing unit 720 to video encoder 722 via a digital video bus (not shown). An audio processing unit 724 and an audio codec (coder/decoder) 726 form a corresponding audio processing pipeline for multi-channel audio processing of various digital audio formats. Audio data are carried between audio processing unit 724 and audio codec 726 via a communication link (not shown). The video and audio processing pipelines output data to an A/V (audio/video) port 728 for transmission to a television or other display. In the illustrated implementation, video and audio processing components 720-728 are mounted on module 714.

FIG. 8 shows module 714 including a USB host controller 730 and a network interface 732. USB host controller 730 is shown in communication with CPU 700 and memory controller 702 via a bus (e.g., PCI bus) and serves as host for peripheral controllers 604(1)-604(4). Network interface 732 provides access to a network (e.g., Internet, home network, etc.) and may be any of a wide variety of various wired or wireless interface components including an Ethernet card, a modem, a wireless access card, a Bluetooth module, a cable modem, and the like.

In the implementation depicted in FIG. 8, console 602 includes a controller support subassembly 740 for supporting four controllers 604(1)-604(4). The controller support subassembly 740 includes any hardware and software components needed to support wired and wireless operation with an external control device, such as for example, a media and game controller. A front panel I/O subassembly 742 supports the multiple functionalities of power button 612, the eject button 614, as well as any LEDs (light emitting diodes) or other indicators exposed on the outer surface of console 602. Subassemblies 740 and 742 are in communication with module 714 via one or more cable assemblies 744. In other implementations, console 602 can include additional controller subassemblies. The illustrated implementation also shows an optical I/O interface 735 that is configured to send and receive signals that can be communicated to module 714.

MUs 640(1) and 640(2) are illustrated as being connectable to MU ports “A” 630(1) and “B” 630(2) respectively. Additional MUs (e.g., MUs 640(3)-640(6)) are illustrated as being connectable to controllers 604(1) and 604(3), i.e., two MUs for each controller. Controllers 604(2) and 604(4) can also be configured to receive MUs (not shown). Each MU 640 offers additional storage on which games, game parameters, and other data may be stored. In some implementations, the other data can include any of a digital game component, an executable gaming application, an instruction set for expanding a gaming application, and a media file. When inserted into console 602 or a controller, MU 640 can be accessed by memory controller 702.

A system power supply module 750 provides power to the components of gaming and media system 600. A fan 752 cools the circuitry within console 602.

An application 760 comprising machine instructions is stored on hard disk drive 708. When console 602 is powered on, various portions of application 760 are loaded into RAM 706, and/or caches 710 and 712, for execution on CPU 700, wherein application 760 is one such example. Various applications can be stored on hard disk drive 708 for execution on CPU 700.

Gaming and media system 600 may be operated as a standalone system by simply connecting the system to monitor 88 (FIG. 1), a television, a video projector, or other display device. In this standalone mode, gaming and media system 600 enables one or more players to play games, or enjoy digital media, e.g., by watching movies, or listening to music. However, with the integration of broadband connectivity made available through network interface 732, gaming and media system 600 may further be operated as a participant in a larger network gaming community.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I claim:

1. A method of propagating data between multiple computing devices, comprising:
a) monitoring a local clipboard buffer of a first computing device of the multiple computing devices for a change in data stored in the local clipboard buffer;
b) transmitting data from the local clipboard buffer of the first computing device to a storage location on a remote server to which the first computing device is operatively coupled upon detecting a change in the data stored in the local clipboard buffer of the first device; and
c) propagating the data stored in the storage location in said step (b) to a local clipboard buffer of a second computing device operatively coupled to the remote server.

2. The method of claim 1, further comprising the step (d) of a user of the first device setting permissions and preferences granting permission for the second computing device receive the data in said step (c).

3. The method of claim 1, further comprising the step (e) of a user of the first device setting permissions and preferences as to the formatting of the data transmitted in said step (b).

4. The method of claim 1, further comprising the step (f) of a user of the second computing device pasting the data into an application running on the second computing device.

5. The method of claim 4, said step (f) of a user of the second computing device pasting the data into an application running on the second computing device comprising the step of a user interacting with the second computing device via a natural user interface.

6. The method of claim 1, further comprising the step (g) of transferring metadata together with the data transferred in said step (b), the metadata including at least one of an identity of the computing device which generated the data, an identity of an application running on the first computing device which generated the data, and a format in which the data is to be transmitted.

7. The method of claim 1, wherein the first and second computing devices are within the collection of computing devices of a single user.

8. The method of claim 1, wherein the first and second computing devices are within the collections of computing devices of two different users.

9. The method of claim 8, wherein the first user sets permissions to send data to the second computing device of the second user, and the second user sets permissions to receive data from the first computing device of the first user.

10. A system for propagating data between computing devices, the system comprising:
a first computing device including:
a first application including data,
a first local clipboard buffer capable of storing data copied to the first local clipboard buffer from the first application, and
a first client clipboard application for synchronizing with the first local clipboard buffer and forwarding the data in the first local clipboard buffer to a remote location;
a service at the remote location, the service including:
a data store for storing the data from the first client clipboard application; and
a second computing device operative coupled to the service at the remote location, the second computing device including:
a second client clipboard application for synchronizing with the data store in the service at the remote location,
a second local clipboard buffer, the second client clipboard application forwarding data received from the data store to the second local clipboard buffer, data in the second local clipboard buffer being replaced with data received from the second client clipboard application, and
a second application, data from the second local clipboard buffer capable of being pasted into the application.

11. The system of claim 10, wherein the data comprises at least one of text, graphics, one or more files, one or more directory of files, and links to this data.

12. The system of claim 10, further comprising a configuration utility for presenting a user interface to the user of the first and/or second devices allowing the user to set preferences and permissions relating to the propagation of data.

13. The system of claim 10, wherein the remote location is an Internet service provider.

14. The system of claim 10, wherein the first and second devices each include an operating system, the first clipboard application included within the operating system of the first computing device, and the second clipboard application included within the operating system of the second computing device.

15. The system of claim 10, wherein the first and second devices are each one of a desktop computer, laptop computer, tablet, cellular telephone, television/set top box, video game console and netbook, and the first and second devices are different types of devices than each other.

16. A computer-readable storage medium for programming a processor to perform a method of propagating data between a collection of computing devices of a single user, the method comprising:
a) synchronizing a local clipboard buffer of a first computing device of a collection of computing devices of the single user to a first client clipboard application on the first computing device;
b) transmitting data from the local clipboard buffer of the first computing device to a storage location on a remote server to which the first computing device is operatively coupled upon detecting a change in the data stored in the local clipboard buffer of the first device; and
c) propagating the data stored in the storage location in said step (b) to local clipboard buffers of a plurality of computing devices in the user's collection of computing devices that are operatively coupled to the remote server.

17. The method of claim 16, further comprising the step (d) of the user of a second computing device in the plurality of computing devices pasting the data into an application running on the second computing device.

18. The method of claim 17, said step (d) of a user of the second computing device pasting the data into an application running on the second computing device comprising the step of a user interacting with the second computing device via a natural user interface.

19. The method of claim 16, further comprising the step (e) of transferring metadata together with the data transferred in said step (b), the metadata including at least one of an identity of the computing device which generated the data, an identity of an application running on the first computing device which generated the data, and a format in which the data is to be transmitted.

20. The method of claim 16, further comprising the step (f) of storing multiple versions of the data transferred in said step (b) on the storage location, the versions being stored in different formats to optimize the usability of the data across different devices ad applications.
